(19) United States
(12) Patent Application Publication
(10) Pub. No.: US 2020/0191817 A1
(43) Pub. Date: Jun. 18, 2020

(54) MULTIPLE WHEEL SPEED SENSOR ASSEMBLY

(71) Applicant: Continental Automotive Systems, Inc., Auburn Hills, MI (US)

(72) Inventors: John B. Horst, Sterling Heights, MI (US); Kenneth Garrigues, Lake Orion, MI (US)

(73) Assignee: Continental Automotive Systems, Inc., Auburn Hills, MI (US)

(21) Appl. No.: 16/675,802

(22) Filed: Nov. 6, 2019

Related U.S. Application Data
(60) Provisional application No. 62/779,272, filed on Dec. 13, 2018.

(51) Int. Cl. G01P 3/44

(52) U.S. Cl. CPC G01P 3/443; B60B 27/0068

(57) ABSTRACT

A wheel speed sensor assembly includes a sensor housing configured to be disposed within a knuckle of a vehicle. The wheel speed sensor assembly further includes a wheel speed sensor sub-assembly that has at least one primary wheel sensor disposed within the sensor housing. The at least one primary wheel sensor is configured to provide data regarding wheel speed, and the at least one primary wheel sensor has at least one primary integrated circuit. The wheel speed sensor sub-assembly further includes at least one supplemental wheel sensor disposed within the sensor housing. The at least one supplemental wheel sensor is configured to provide data regarding wheel speed, and the at least one supplemental wheel sensor includes at least one supplemental integrated circuit.

### CROSS-REFERENCE TO RELATED APPLICATIONS

This application claims the benefit of Provisional Application 62/779,272, filed Dec. 13, 2018. The disclosure of the above application is incorporated herein by reference.

### TECHNICAL FIELD

This disclosure relates to a multiple wheel speed sensor assembly and related methods.

### TECHNICAL BACKGROUND

Highly automated driving (HAD) requires redundancy of the brake system, for example using two or more control units. A primary (master) control unit is used for normal operation, and a supplemental (back-up) control unit is used when the primary control unit experiences a functional or electrical failure. The primary control unit and the supplemental control unit both need wheel speed information in order to function properly.

Wheel speed detection systems evaluate the sensor output signals of speed sensors of a motor vehicle and calculate the speed of the motor vehicle by using, for example, a stored wheel variable such as the wheel diameter. There is a potential risk of signal loss, functional or electrical failure of both the primary control unit and the supplemental control unit if both the control units share the same wheel speed sensors.

What is needed is a better way to electrically separate the wheel speed sensors, and to provide redundant sensors for high automated driving vehicles without increasing manufacturing complexity.

### BRIEF SUMMARY

A wheel speed sensor assembly including a wheel speed sensor assembly includes a sensor housing configured to be disposed within a knuckle of a vehicle. The wheel speed sensor assembly further includes a wheel speed sensor sub-assembly that has at least one primary wheel sensor disposed within the sensor housing. The at least one primary wheel sensor is configured to provide data regarding wheel speed, and the at least one primary wheel sensor has at least one primary integrated circuit. The wheel speed sensor sub-assembly further includes at least one supplemental wheel sensor disposed within the sensor housing. The at least one supplemental wheel sensor is configured to provide data regarding wheel speed, and the at least one supplemental wheel sensor includes at least one supplemental integrated circuit.

In one or more embodiments, the wheel speed sensor assembly further includes at least one primary carrier, the at least one primary integrated circuit disposed within the at least one primary carrier.

In one or more embodiments, the wheel speed sensor assembly further includes at least one supplemental carrier, the at least one supplemental integrated circuit disposed within the at least one supplemental carrier.

In one or more embodiments, the wheel speed sensor assembly further includes a single cable coupled with the at least one primary wheel sensor and the at least one supplemental wheel sensor, the single cable including wires configured to communicate information from the at least one primary wheel sensor and the at least one supplemental wheel sensor.

In one or more embodiments, the wheel speed sensor assembly further includes multiple cables, where each of the at least one primary and the at least one supplemental sensors have an individual cable.

In one or more embodiments, the wheel speed sensor sub-assembly is molded.

In one or more embodiments, the at least one supplemental wheel sensor becomes a primary wheel sensor upon failure of the at least one primary wheel sensor.

In one or more embodiments, the sensor housing includes a multi-sensor hub ring having a ring-shape with an open center.

In one or more embodiments, the sensor housing includes a multi-sensor hub ring having a disc-shape.

A wheel speed sensor assembly has a dual-sensor sensor housing that is configured to be disposed within a knuckle of a vehicle and a wheel speed sensor sub-assembly. The wheel speed sensor sub-assembly including a primary wheel sensor is disposed within the dual-sensor sensor housing, and the primary wheel sensor configured to provide data regarding wheel speed. The at least one primary wheel sensor includes at least one primary integrated circuit, and at least one supplemental wheel sensor is disposed within the dual-sensor sensor housing. The at least one supplemental wheel sensor is configured to provide data regarding wheel speed, and the at least one supplemental wheel sensor includes at least one supplemental integrated circuit. The wheel speed sensor assembly further includes a primary carrier, where the primary integrated circuit is disposed within the primary carrier, and a supplemental carrier where the supplemental integrated circuit is disposed within the supplemental carrier. At least one cable is coupled with at least one of the primary wheel sensor or the supplemental wheel sensor, where the single cable includes wires configured to communicate information from the at least one primary wheel sensor or the supplemental wheel sensor.

In one or more embodiments, the wheel speed sensor sub-assembly is molded.

In one or more embodiments, the supplemental wheel sensor becomes a primary wheel sensor upon failure of the at least one primary wheel sensor.

In one or more embodiments, the dual-sensor sensor housing includes a multi-sensor hub ring having a ring-shape with an open center.

In one or more embodiments, the multi-sensor hub ring has a disc-shape.

In one or more embodiments, the wheel speed sensor assembly further includes multiple cables, where each of the at least one primary and the at least one supplemental sensors have an individual cable.

### BRIEF DESCRIPTION OF THE DRAWINGS

FIG. 1 illustrates a perspective view of a wheel speed sensor assembly, as constructed in accordance with one or more embodiments.

FIG. 2 illustrates an exploded perspective view of a wheel speed sensor assembly, as constructed in accordance with one or more embodiments.

FIG. 3 illustrates a perspective view of a wheel speed sensor assembly, as constructed in accordance with one or more embodiments.

FIG. 4 illustrates an exploded perspective view of a wheel speed sensor assembly, as constructed in accordance with one or more embodiments.

FIG. 5 illustrates a perspective view of a wheel speed sensor assembly, as constructed in accordance with one or more embodiments.

FIG. 6 illustrates an exploded perspective view of a wheel speed sensor assembly, as constructed in accordance with one or more embodiments.

FIG. 7 illustrates a perspective view of a wheel speed sensor assembly, as constructed in accordance with one or more embodiments.

FIG. 8 illustrates an exploded perspective view of a wheel speed sensor assembly, as constructed in accordance with one or more embodiments.

FIG. 9 illustrates a perspective view of a wheel speed sensor sub-assembly, as constructed in accordance with one or more embodiments.

FIG. 10 illustrates an exploded perspective view of a wheel speed sensor assembly, as constructed in accordance with one or more embodiments.

FIG. 11 illustrates a perspective view of a wheel speed sensor assembly installed in a knuckle, as constructed in accordance with one or more embodiments.

FIG. 12 illustrates a perspective view of a wheel speed sensor assembly, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

Various control systems for vehicles use wheel speed for example to determine when the wheels are spinning and taking appropriate control action to maintain the vehicle's stability and steering responses. The control systems determine the wheel speed based on signals sent by wheel speed sensors. A wheel speed sensor assembly as described herein includes multiple sensors, such as dual sensors to provide a primary wheel sensor and a supplemental wheel sensor.

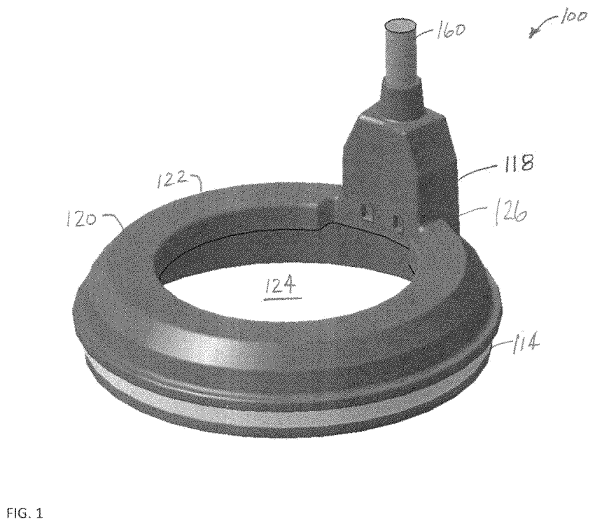

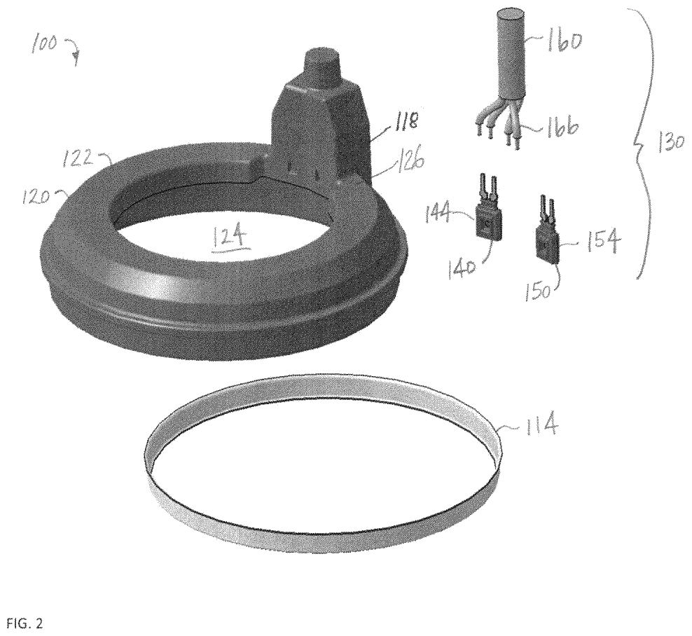

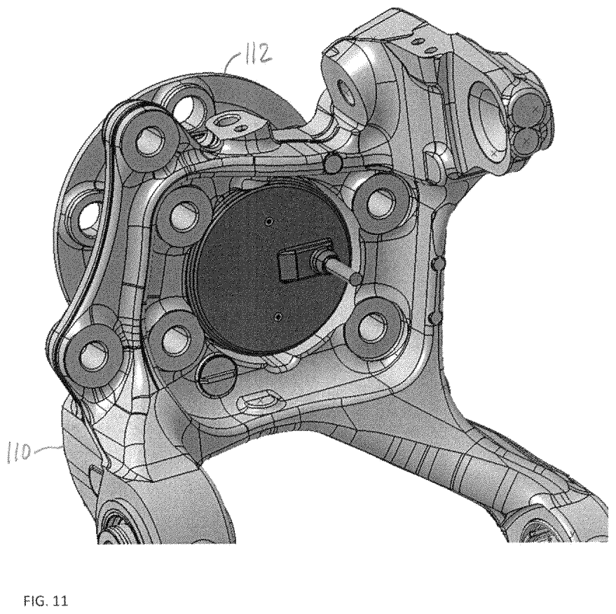

Referring to FIGS. 1-2, a wheel speed sensor assembly 100 is shown. The wheel speed sensor assembly 100 includes a sensor housing 118. In one or more embodiments, the sensor housing 118 is a multi-sensor hub ring 120, such as a dual-sensor hub ring, that is configured to be disposed within a knuckle 110 (FIG. 11) of a vehicle and mounted to a vehicle bearing 112 to read the speed of the encoder. The multi-sensor hub ring 120 optionally includes an outer metal ring 114. In one or more embodiments, the multi-sensor hub ring 120 further includes a cap 122 and has a general ring shape with an open center 124.

The wheel speed sensor assembly 100 further includes a wheel speed sensor sub-assembly 130 that has at least one primary wheel sensor 140 disposed within the multi-sensor hub ring 120. The at least one primary wheel sensor 140 is configured to provide data regarding wheel speed, for example to a processor for an ABS. The at least one primary wheel sensor 140 includes at least one primary integrated circuit 144. The wheel speed sensor sub-assembly 130 further includes at least one supplemental wheel sensor 150 disposed within the multi-sensor hub ring 120. The at least one supplemental wheel sensor 150 configured to provide data regarding wheel speed. The at least one supplemental wheel sensor 150 includes at least one supplemental integrated circuit 154. The at least one supplemental wheel sensor 150 is configured to provide data regarding wheel speed when the at least one primary wheel sensor 140 is inoperable. In one or more embodiments, the at least one supplemental wheel sensor becomes a primary wheel sensor upon failure of the at least one primary wheel sensor 140.

In one or more embodiments, a single cable 160 is coupled with the at least one primary wheel sensor 140 and the at least one supplemental wheel sensor 150, the single cable 160 including wires 166 configured to communicate information from the at least one primary wheel sensor 140 and the at least one supplemental wheel sensor 150. In one or more embodiments, the at least one primary wheel sensor 140 and the at least one supplemental wheel sensor 150 are disposed along the outer ring portion 126 of the multi-sensor hub ring 120.

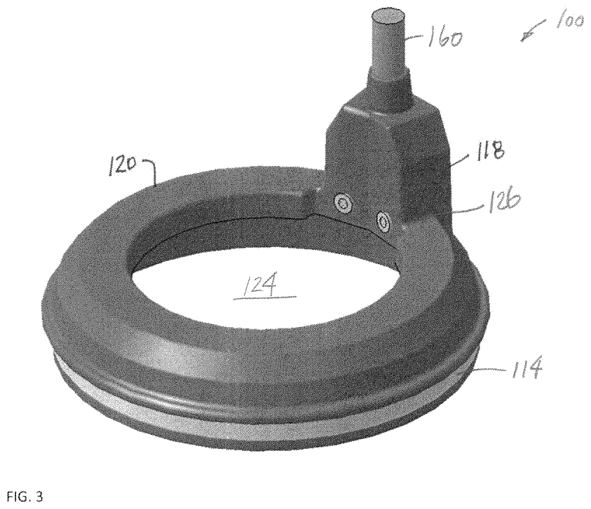

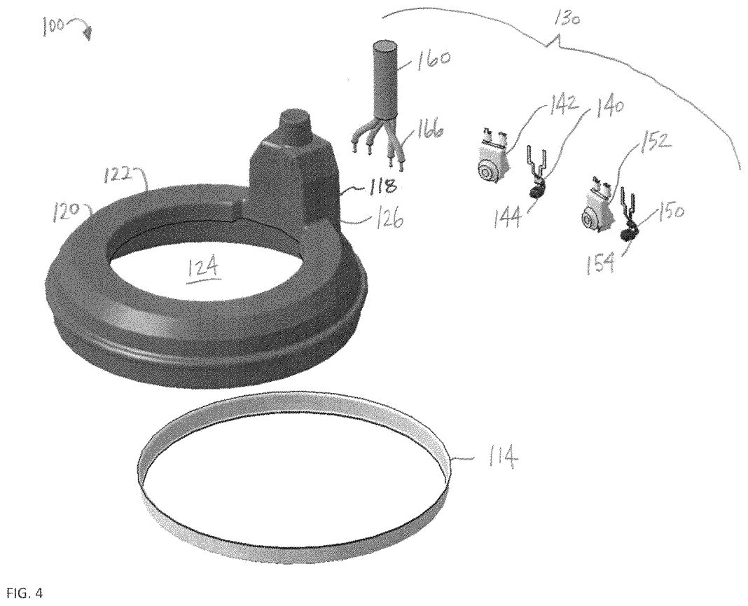

FIGS. 3-4 illustrate another embodiment of a wheel speed sensor assembly 100 is shown. The wheel speed sensor assembly 100 includes a sensor housing 118. In one or more embodiments, the sensor housing 118 is a multi-sensor hub ring 120 that is configured to be disposed within a knuckle 110 (FIG. 11) of a vehicle and mounted to a vehicle bearing 112 to read the speed of the encoder. The multi-sensor hub ring 120 optionally includes an outer metal ring 114. In one or more embodiments, the multi-sensor hub ring 120 further includes a cap 122 and has a general ring shape with an open center 124.

The wheel speed sensor assembly 100 further includes a wheel speed sensor sub-assembly 130 that has at least one primary wheel sensor 140 disposed within the multi-sensor hub ring 120. The at least one primary wheel sensor 140 is configured to provide data regarding wheel speed, for example to a processor for an ABS. The at least one primary wheel sensor 140 includes at least one primary integrated circuit 144. The wheel speed sensor sub-assembly 130 further includes at least one supplemental wheel sensor 150 disposed within the multi-sensor hub ring 120. The at least one supplemental wheel sensor 150 configured to provide data regarding wheel speed. The wheel speed sensor sub-assembly 130 further includes a primary carrier 142, where the at least one primary integrated circuit 144 is disposed within the at least one primary carrier 142. The at least one primary carrier 142 holds the primary integrated circuit 144 in place, for example, during the molding process which also seals the primary integrated circuit 144 from the environment.

The at least one supplemental wheel sensor 150 includes at least one supplemental integrated circuit 154. The at least one supplemental wheel sensor 150 is configured to provide data regarding wheel speed when the at least one primary wheel sensor 140 is inoperable. In one or more embodiments, the at least one supplemental wheel sensor becomes a primary wheel sensor upon failure of the at least one primary wheel sensor 140.

The wheel speed sensor sub-assembly 130 further includes a supplemental carrier 152, where the at least one supplemental integrated circuit 154 is disposed within the at least one supplemental carrier 152. The at least one supplemental carrier 152 holds the supplemental integrated circuit 154 in place, for example, during the molding process which also seals the primary integrated circuit 144 from the environment.

In one or more embodiments, a single cable 160 is coupled with the at least one primary wheel sensor 140 and the at least one supplemental wheel sensor 150, the single cable 160 including wires 166 configured to communicate information from the at least one primary wheel sensor 140 and the at least one supplemental wheel sensor 150. In one or more embodiments, the at least one primary wheel sensor 140 and the at least one supplemental wheel sensor 150 are disposed along the outer ring portion 126 of the multi-sensor hub ring 120.

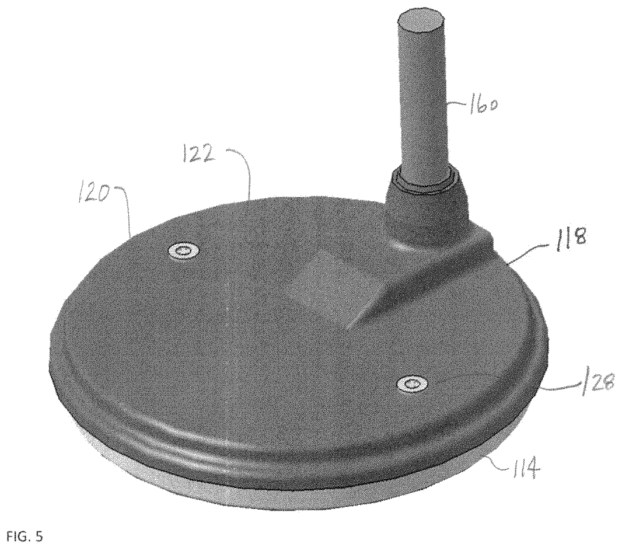

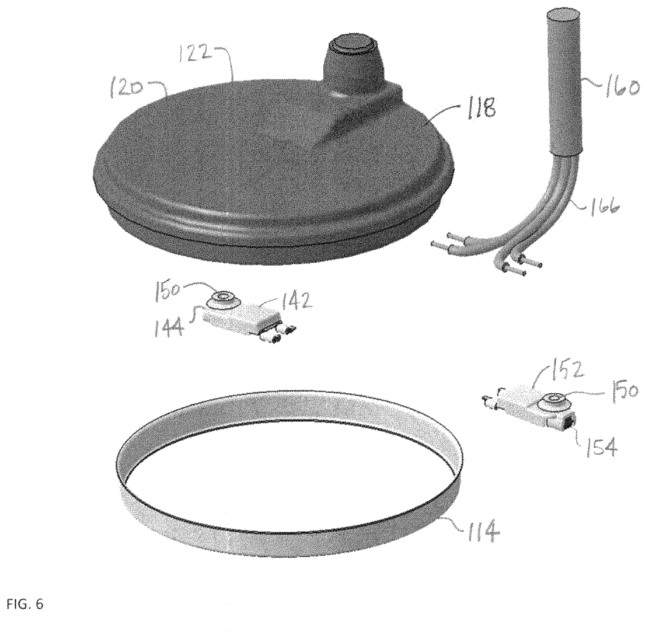

FIGS. 5-6 illustrate another embodiment of a wheel speed sensor assembly 100 is shown. The wheel speed sensor assembly 100 includes a sensor housing 118. In one or more embodiments, the sensor housing 118 includes a multi-sensor hub ring 120 that is configured to be disposed within a knuckle 110 (FIG. 11) of a vehicle and mounted to a vehicle bearing 112 to read the speed of the encoder. The multi-sensor hub ring 120 optionally includes an outer metal ring 114. In one or more embodiments, the multi-sensor hub ring 120 further includes a cap 122 and has a general disc shape with a central disc portion 128.

The wheel speed sensor assembly 100 further includes a wheel speed sensor sub-assembly 130 that has at least one primary wheel sensor 140 disposed within the multi-sensor hub ring 120. The at least one primary wheel sensor 140 is configured to provide data regarding wheel speed, for example to a processor for an ABS. The at least one primary wheel sensor 140 includes at least one primary integrated circuit 144. The wheel speed sensor sub-assembly 130 further includes at least one supplemental wheel sensor 150 disposed within the multi-sensor hub ring 120. The at least one supplemental wheel sensor 150 configured to provide data regarding wheel speed. The wheel speed sensor sub-assembly 130 further includes a primary carrier 142, where the at least one primary integrated circuit 144 is disposed within the at least one primary carrier 142. The at least one primary carrier 142 holds the primary integrated circuit 144 in place, for example, during the molding process which also seals the primary integrated circuit 144 from the environment.

The at least one supplemental wheel sensor 150 includes at least one supplemental integrated circuit 154. The at least one supplemental wheel sensor 150 is configured to provide data regarding wheel speed when the at least one primary wheel sensor 140 is inoperable. In one or more embodiments, the at least one supplemental wheel sensor 150 becomes a primary wheel sensor upon failure of the at least one primary wheel sensor 140.

The wheel speed sensor sub-assembly 130 further includes a supplemental carrier 152, where the at least one supplemental integrated circuit 154 is disposed within the at least one supplemental carrier 152. The at least one supplemental carrier 152 holds the supplemental integrated circuit 154 in place, for example, during the molding process which also seals the primary integrated circuit 144 from the environment.

In one or more embodiments, a single cable 160 is coupled with the at least one primary wheel sensor 140 and the at least one supplemental wheel sensor 150, the single cable 160 including wires 166 configured to communicate information from the at least one primary wheel sensor 140 and the at least one supplemental wheel sensor 150. In one or more embodiments, the at least one primary wheel sensor 140 and the at least one supplemental wheel sensor 150 are disposed within the central disc portion 128 of the multi-sensor hub ring 120.

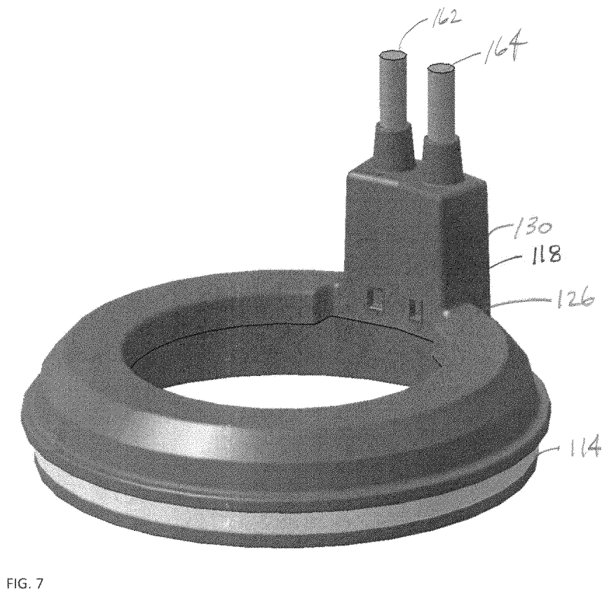

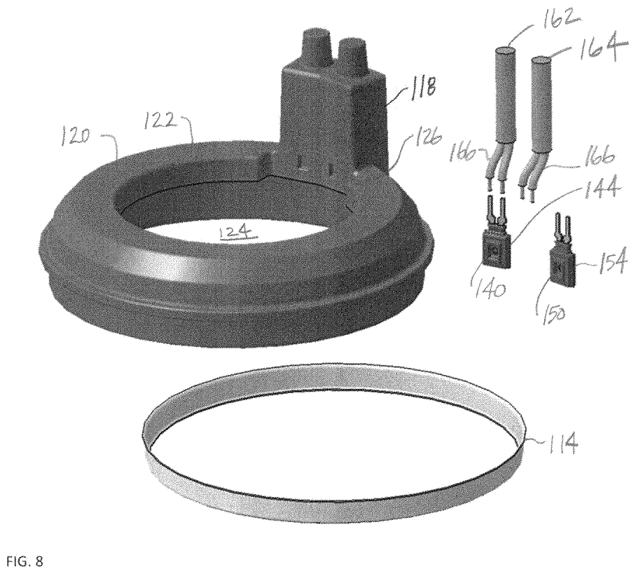

Referring to FIGS. 7-8, another embodiment of a wheel speed sensor assembly 100 is shown. The wheel speed sensor assembly 100 includes a sensor housing 118. In one or more embodiments, the sensor housing 118 includes a multi-sensor hub ring 120 that is configured to be disposed within a knuckle 110 (FIG. 11) of a vehicle and mounted to a vehicle bearing 112 to read the speed of the encoder. The multi-sensor hub ring 120 optionally includes an outer metal ring 114. In one or more embodiments, the multi-sensor hub ring 120 further includes a cap 122 and has a general ring shape with an open center 124.

The wheel speed sensor assembly 100 further includes a wheel speed sensor sub-assembly 130 that has at least one primary wheel sensor 140 disposed within the multi-sensor hub ring 120. The at least one primary wheel sensor 140 is configured to provide data regarding wheel speed, for example to a processor for an ABS. The at least one primary wheel sensor 140 includes at least one primary integrated circuit 144. The wheel speed sensor sub-assembly 130 further includes at least one supplemental wheel sensor 150 disposed within the multi-sensor hub ring 120. The at least one supplemental wheel sensor 150 configured to provide data regarding wheel speed. The at least one supplemental wheel sensor 150 includes at least one supplemental integrated circuit 154. The at least one supplemental wheel sensor 150 is configured to provide data regarding wheel speed when the at least one primary wheel sensor 140 is inoperable. In one or more embodiments, the at least one supplemental wheel sensor 150 becomes a primary wheel sensor upon failure of the at least one primary wheel sensor 140.

In one or more embodiments, dual cables are provided, where a primary cable 162 is coupled with the at least one primary wheel sensor 140, and a supplemental cable 164 is coupled with the at least one supplemental wheel sensor 150. In one or more embodiments, each of the at least one primary and the at least one supplemental sensors 140, 150 has an individual cable. The dual cables, which include wires 166, are configured to communicate information from the at least one primary wheel sensor 140 and the at least one supplemental wheel sensor 150. In one or more embodiments, the at least one primary wheel sensor 140 and the at least one supplemental wheel sensor 150 are disposed along the outer ring portion 126 of the multi-sensor hub ring 120.

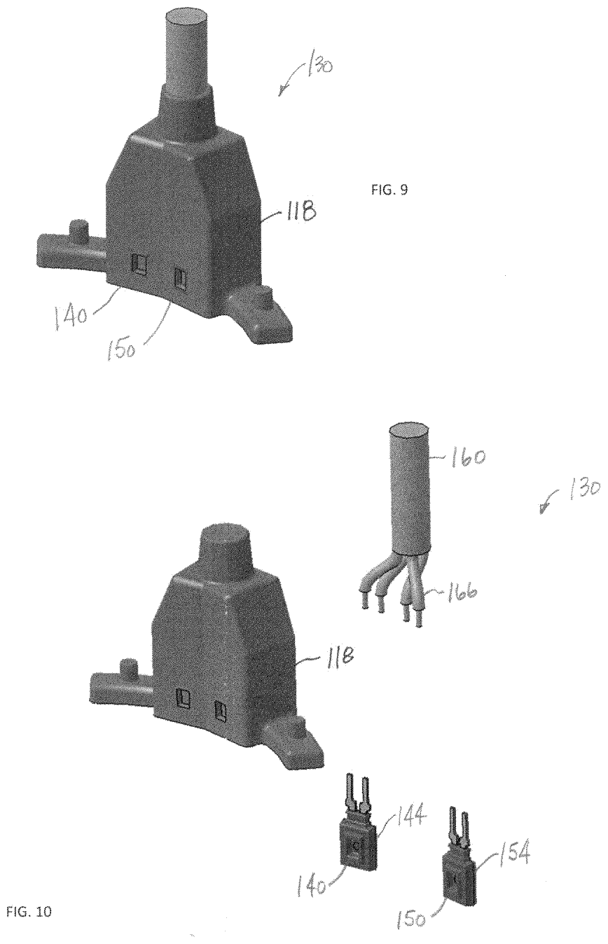

In the above discussed embodiments, the wheel speed sensor subassembly 130 can be molded integral with the multi-sensor hub ring. FIGS. 9-10 illustrate another embodiment of the wheel speed sensor subassembly 130 having a sensor housing 118, such as a molded sensor housing. The wheel sensor subassembly 130 includes the variations described above. In one or more embodiments, the wheel sensor sub-assembly 130 is formed separate from the multi-sensor hub ring, and includes coupling features 132, for example arms with projections or recesses allowing for the wheel speed sensor subassembly 130 to be coupled with a housing, or for mating to a secondary ring. Other alternative embodiments include providing a metal cap and mounting two sensors to the cap by various methods, including, but not limited to, heat staking, clipping, or using a separate fastener.

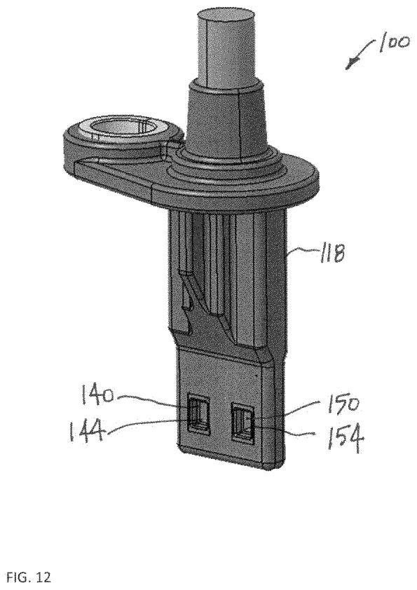

FIG. 12 illustrates another embodiment of the wheel speed sensor subassembly 130, which includes a molded sensor assembly having two or more wheel sensors and related integrated circuits. The wheel speed sensor subassembly includes a sensor housing 118, such as a molded sensor housing 118. The molded housing will protect the inner circuits and wiring from exposure to the elements. In one or more embodiments, the wheel speed sensor subassembly 130 includes dual wheel sensors having a primary sensor 140, an at least one primary integrated circuit 144, at least one supplemental sensor 150, and a supplemental integrated circuit 154. The integrated circuits are communicatively coupled with a cable, such as a single cable 160.

The at least one primary wheel sensor 140 and the at least one supplemental wheel sensor 150 are configured to provide data regarding wheel speed, for example to a processor for an ABS. The at least one supplemental wheel sensor 150 is configured to provide data regarding wheel speed when the at least one primary wheel sensor 140 is inoperable. In one or more embodiments, the at least one supplemental wheel sensor becomes a primary wheel sensor upon failure of the at least one primary wheel sensor 140.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A wheel speed sensor assembly comprising:
a sensor housing configured to be disposed within a knuckle of a vehicle; and
a wheel speed sensor sub-assembly including at least one primary wheel sensor disposed within the , the at least one primary wheel sensor configured to provide data regarding wheel speed, the at least one primary wheel sensor including at least one primary integrated circuit, and at least one supplemental wheel sensor disposed within the , the at least one supplemental wheel sensor configured to provide data regarding wheel speed, the at least one supplemental wheel sensor including at least one supplemental integrated circuit.

2. The wheel speed sensor assembly as recited in claim 1, further comprising at least one primary carrier, the at least one primary integrated circuit disposed within the at least one primary carrier.

3. The wheel speed sensor assembly as recited in claim 1, further comprising at least one supplemental carrier, the at least one supplemental integrated circuit disposed within the at least one supplemental carrier.

4. The wheel speed sensor assembly as recited in claim 1, further comprising a single cable coupled with the at least one primary wheel sensor and the at least one supplemental wheel sensor, the single cable including wires configured to communicate information from the at least one primary wheel sensor and the at least one supplemental wheel sensor.

5. The wheel speed sensor assembly as recited in claim 1, further comprising multiple cables, where each of the at least one primary and the at least one supplemental wheel sensor has an individual cable.

6. The wheel speed sensor assembly as recited in claim 1, wherein the at least one supplemental wheel sensor becomes the primary wheel sensor upon failure of the at least one primary wheel sensor.

7. The wheel speed sensor assembly as recited in claim 1, wherein the sensor housing is a multi-sensor hub ring.

8. The wheel speed sensor assembly as recited in claim 7, wherein the wheel speed sensor sub-assembly is molded with the multi-sensor hub ring.

9. The wheel speed sensor assembly as recited in claim 7, wherein the multi-sensor hub ring has a ring-shape with an open center.

10. The wheel speed sensor assembly as recited in claim 7, wherein the multi-sensor hub ring has a disc-shape.

11. A wheel speed sensor assembly comprising:
a dual-sensor sensor housing configured to be disposed within a knuckle of a vehicle; and
a wheel speed sensor sub-assembly including at least one primary wheel sensor disposed within the dual-sensor sensor housing, the primary wheel sensor configured to provide data regarding wheel speed, the at least one primary wheel sensor including at least one primary integrated circuit, and at least one supplemental wheel sensor disposed within the dual-sensor sensor housing, the at least one supplemental wheel sensor configured to provide data regarding wheel speed, the at least one supplemental wheel sensor including at least one supplemental integrated circuit;
a primary carrier, the primary integrated circuit disposed within the primary carrier;
a supplemental carrier, the supplemental integrated circuit disposed within the supplemental carrier; and
at least one cable coupled with at least one of the primary wheel sensor or the supplemental wheel sensor, the at least one cable including wires configured to communicate information from the at least one primary wheel sensor or the supplemental wheel sensor.

12. The wheel speed sensor assembly as recited in claim 11, wherein the dual-sensor sensor housing is molded.

13. The wheel speed sensor assembly as recited in claim 11, wherein the supplemental wheel sensor becomes a primary wheel sensor upon failure of the at least one primary wheel sensor.

14. The wheel speed sensor assembly as recited in claim 11, wherein the dual-sensor sensor housing is a dual-sensor hub ring.

15. The wheel speed sensor assembly as recited in claim 14, wherein the dual-sensor hub ring has a ring-shape with an open center.

16. The wheel speed sensor assembly as recited in claim 14, wherein the multi-sensor hub ring has a disc-shape.

17. The wheel speed sensor assembly as recited in claim 11, further comprising multiple cables, where each of the at least one primary and the at least one supplemental wheel sensors have an individual cable.
